(19) United States
(12) Patent Application Publication
(10) Pub. No.: US 2017/0008567 A1
(43) Pub. Date: Jan. 12, 2017

(54) DOOR PILLAR FOR VEHICLE AND METHOD OF MANUFACTURING THE SAME

(71) Applicant: Kl IL KIM, Changwon-si, Gyeongsangnam-do (KR)

(72) Inventor: Kl IL KIM, Changwon-si, Gyeongsangnam-do (KR)

(21) Appl. No.: 15/114,998

(22) PCT Filed: Dec. 15, 2015
(86) PCT No.: PCT/KR2015/013728

§ 371 Date: Jul. 28, 2016

(30) Foreign Application Priority Data
Mar. 9, 2015 (KR) 10-2015-0032195
Mar. 24, 2015 (KR) 10-2015-0040431

(51) Int. Cl. B62D 25/04; B62D 29/00; B62D 65/14

(52) U.S. Cl. CPC B62D 25/04; B62D 65/14; B62D 29/004

(57) ABSTRACT

According to the present invention, the door pillar is manufactured in such a way that the mold, into which polymethyl methacrylate has been injected, is divided into several sections and the respective sections of the mold are cooled at different temperatures, and accordingly, a painting process is not needed. As a result, the process of manufacturing the door pillar is simplified, and the door pillar can be manufactured in an environmentally friendly way without the emission of environmental pollutants.

### TECHNICAL FIELD

The present invention relates to a door pillar for a vehicle and, more particularly, to a door pillar for a vehicle which is made of synthetic resin, thereby reducing the weight thereof and improving productivity.

A door pillar for a vehicle according to the present invention includes a body part and a wing part. The wing part includes a bracket having a through hole therein so as to be secured to a vehicle body using a screw, a protrusion formed to be inserted into the vehicle body in order to fix the position of the through hole, and a guide rail formed to be coupled to a portion of the body part in order to guide the sliding movement of a vehicle window. The body part and the wing part are integrally formed through injection molding using synthetic resin.

In the above door pillar for a vehicle, the wing part preferably further includes a plurality of injection holes formed in the longitudinal direction in order to prevent variation in size during the injection molding of synthetic resin.

According to the present invention, since the body part and the wing part are integrally formed through injection molding using synthetic resin, the process of manufacturing the door pillar for a vehicle is simplified, and the weight of the door pillar is reduced.

A method of manufacturing the above door pillar for a vehicle according to the present invention has the purpose of manufacturing the door pillar through injection molding using polymethyl methacrylate in order to obviate a painting process.

The method of manufacturing the door pillar for a vehicle according to an exemplary embodiment of the present invention includes a drying step, an introducing step, a heating step, a measuring step, an injecting step, and a cooling step. In the drying step, polymethyl methacrylate is dried. In the introducing step, polymethyl methacrylate, which has been dried in the drying step, is introduced into a cylinder for injection molding. In the heating step, the cylinder, into which polymethyl methacrylate has been introduced, is heated at different temperatures in multiple stages in the longitudinal direction thereof. In the measuring step, the amount of polymethyl methacrylate to be used for injection molding is measured. In the injecting step, the measured polymethyl methacrylate is injected into a mold in the longitudinal direction of the mold by applying pressures ranging from a high level to a low level in multiple stages. In the cooling step, the mold, into which polymethyl methacrylate has been injected, is cooled at different temperatures in multiple stages from an inlet hole to the opposite end in the longitudinal direction.

According to the present invention, the door pillar is manufactured in such a way that the mold, into which polymethyl methacrylate has been injected, is divided into several sections and the respective sections of the mold are cooled at different temperatures, and accordingly, a painting process is not needed. As a result, the process of manufacturing the door pillar is simplified, and the door pillar can be manufactured in an environmentally friendly way without the emission of environmental pollutants.

### BACKGROUND ART

A conventional door pillar for a vehicle is mounted to a door of the vehicle in order to give the vehicle a nice appearance and to guide the sliding movement of the window of the vehicle. To this end, the door pillar needs to have a good appearance and also to be firm enough to guide the sliding movement of the window and withstand a certain load.

Therefore, in order to satisfy the above conditions, the door pillar has been manufactured through roll forming and press processes using metal having good formability. However, manufacturing the door pillar using metal has problems in that the weight of the vehicle body is increased due to the heavy weight of the metal and the manufacturing cost is increased due to the high price of the metal.

Accordingly, as shown in FIG. 1, a recently developed door pillar is divided into a wing part 63, which is coupled to a doorframe 50 of the vehicle, and a body part 61, which is exposed to the outside of the vehicle, and the wing part 63 is made of metal and secured to the vehicle body through welding or the like because it guides the sliding movement of the vehicle window and is subjected to a large load. Since the body part 61 does not bear any load, it is made through injection molding using synthetic resin and coupled to the vehicle body.

The above-described conventional door pillar is manufactured in such a way that the door pillar is formed through roll forming and press processes using metal and is then painted, or in such a way that a decorative door pillar, which is formed through plastic injection molding and painted, is attached to a door module.

Therefore, the painting process is essential to a portion of the door pillar and tape adherence is applied to the remaining portion of the door pillar. However, the painting work must precede the tape adherence. In other words, the painting process is essential to the manufacture of every portion of the door pillar.

### DISCLOSURE

### Technical Problem

Since the conventional door pillar, which includes the body part 61 of synthetic resin and the wing part 63 of metal, undergoes the metal forming process, it has a problem in that the manufacturing method thereof is complicated.

Further, since the wing part 63 is formed using metal, the conventional door pillar has a problem in that it is still heavy.

The present invention is devised to solve the above problems. An object of the present invention is to provide a door pillar for a vehicle, in which a body part 61 and a wing part 63 are integrally formed using synthetic resin.

Furthermore, in relation to the above-described door pillar for a vehicle, the painting process performed during the manufacture of the door pillar for a vehicle generates VOCs (Volatile Organic Compounds) and consists of six complicated processes, including a primer process. Because VOCs have high vapor pressure, they easily evaporate in the atmosphere, and undergo a photochemical reaction by being affected by the sunlight when coexisting with nitrogen oxide in the atmosphere, which results in photochemical smog comprising ozone and PAN (Peroxyacetyl nitrate).

As described above, since the conventional door pillar for a vehicle undergoes a painting process, the manufacturing process is complicated, working efficiency is not high, and environmental contamination occurs.

The present invention is devised to solve the above problems. Another object of the present invention is to provide a method of manufacturing a door pillar through injection molding using polymethyl methacrylate (PMMA) without a painting process.

### Technical Solution

The object of the present invention can be achieved by providing a door pillar for a vehicle including a body part and a wing part. The wing part includes a bracket having a through hole therein so as to be secured to a vehicle body using a screw, a protrusion formed to be inserted into the vehicle body in order to fix the position of the through hole, and a guide rail formed to be coupled to a portion of the body part in order to guide the sliding movement of a vehicle window, and the door pillar further includes a metal clip for surrounding the bracket in order to protect the bracket, the metal clip being formed so that a screw is inserted therethrough. The body part and the wing part are integrally formed through injection molding using synthetic resin.

Preferably, in the above door pillar for a vehicle, the wing part may further include a plurality of injection holes formed in a longitudinal direction in order to prevent variation in size during the injection molding using synthetic resin.

Preferably, in the above door pillar for a vehicle, the wing part may further include a plurality of reinforcement ribs coupled to a portion of the body part in order to increase hardness.

Preferably, in the above door pillar for a vehicle, when an upper surface of the body part of the door pillar has a thickness in a range from 3 to 5 mm, the reinforcement rib may be formed to have a thickness in a range from 1 to 2 mm, and when an upper surface of the body part of the door pillar has a thickness of 4 mm, the reinforcement rib may be formed to have a thickness in a range from 1 to 1.2 mm.

In another aspect of the present invention, provided herein is a method of manufacturing the door pillar for a vehicle, which includes a drying step, an introducing step, a heating step, a measuring step, an injecting step, and a cooling step. In the drying step, polymethyl methacrylate is dried. In the introducing step, polymethyl methacrylate, which has been dried in the drying step, is introduced into a cylinder for injection molding. In the heating step, the cylinder, into which polymethyl methacrylate has been introduced, is heated at different temperatures in multiple stages in the longitudinal direction thereof. In the measuring step, the amount of polymethyl methacrylate to be used for injection molding is measured. In the injecting step, the measured polymethyl methacrylate is injected into a mold in the longitudinal direction of the mold by applying pressures ranging from a high level to a low level in multiple stages. In the cooling step, the mold, into which polymethyl methacrylate has been injected, is cooled at different temperatures in multiple stages from an inlet hole to the opposite end in the longitudinal direction.

Preferably, in the method of manufacturing the door pillar for a vehicle, the heating may include heating the cylinder at different temperatures ranging from a low level to a high level in multiple stages from a region near an inlet hole of the cylinder to a region distant from the inlet hole in a longitudinal direction of the cylinder. Preferably, the cooling may include cooling the mold at different temperatures ranging from a low level to a high level in multiple stages from a region near the inlet hole of the mold to a region distant from the inlet hole in the longitudinal direction of the mold. Accordingly, variation in the surface gloss levels in different regions of the door pillar may be reduced.

Preferably, in the method of manufacturing the door pillar for a vehicle, the cooling may include individually supplying cooling water of different temperatures to respective cooling water lines formed in the mold in multiple stages along the longitudinal direction of the mold.

The method of manufacturing the door pillar for a vehicle may further include closing the mold between the heating and the measuring.

The method of manufacturing the door pillar for a vehicle may further include opening the mold after the cooling.

The method of manufacturing the door pillar for a vehicle may further include removing a product from the mold after the opening, and closing the mold after the removing.

The method of manufacturing the door pillar for a vehicle may further include processing the product to remove a remaining gate from the product after the closing that is performed after the removing.

### Advantageous Effects

According to the above-described door pillar for a vehicle, since the body part and the wing part are integrally formed through injection molding using synthetic resin, the process of manufacturing the door pillar for a vehicle is simplified, and the weight of the door pillar can be reduced.

Further, since the protrusion is formed at the wing part, when the door pillar is secured to a doorframe of the vehicle, the protrusion is inserted into the doorframe of the vehicle, thereby fixing the position of the through hole of the bracket. Accordingly, the door pillar can be easily assembled to the doorframe of the vehicle.

Further, since the injection hole is formed in the wing part, variation in size can be minimized during the injection molding of synthetic resin. Accordingly, an integral door pillar can be formed through injection molding using synthetic resin.

Furthermore, since the reinforcement rib is formed at the wing part, hardness can be increased even though synthetic resin is used for the product.

According to the method of manufacturing the door pillar for a vehicle, the door pillar is manufactured in such a way that the mold, into which polymethyl methacrylate has been injected, is divided into several sections and the respective sections of the mold are cooled at different temperatures, and accordingly, a door pillar having surface gloss as good as that to which a painting process has been applied can be manufactured without the necessity of such a painting process. As a result, the process of manufacturing the door pillar is simplified, and the door pillar can be manufactured in an environmentally friendly way without the emission of environmental pollutants.

### DESCRIPTION OF DRAWINGS

FIG. 1 shows a conceptual view of a section of a conventional door pillar.

FIG. 2 shows a perspective view of an exemplary embodiment of a door pillar according to the present invention.

FIG. 3 shows a perspective view when observing the embodiment of the door pillar according to the present invention shown in FIG. 1 from a different direction.

FIG. 4 shows a perspective view when observing the embodiment of the door pillar according to the present invention shown in FIG. 1 from yet another different direction.

FIG. 5 shows a perspective view when observing the embodiment of the door pillar according to the present invention shown in FIG. 1 from the other different direction, which illustrates an input gate.

FIG. 6 shows a partial enlarged view of the door pillar according to the present invention shown in FIG. 1.

FIG. 7 shows a conceptual view of a section of the door pillar according to the present invention shown in FIG. 1.

FIG. 8 shows a conceptual view illustrating the embodiment of the door pillar according to the present invention shown in FIG. 1, attached to a vehicle.

FIG. 9 shows a conceptual view of a method of manufacturing a door pillar for a vehicle according to one embodiment of the present invention.

FIG. 10 shows a conceptual view of a method of manufacturing a door pillar for a vehicle according to another embodiment of the present invention.

FIG. 11 shows a conceptual view of a mold device for manufacturing the door pillar for a vehicle shown in FIGS. 9 and 10 in the method of manufacturing the door pillar according to the present invention.

FIG. 12 shows a conceptual view of a mold of the mold device shown in FIG. 11 in the method of manufacturing the door pillar according to the present invention.

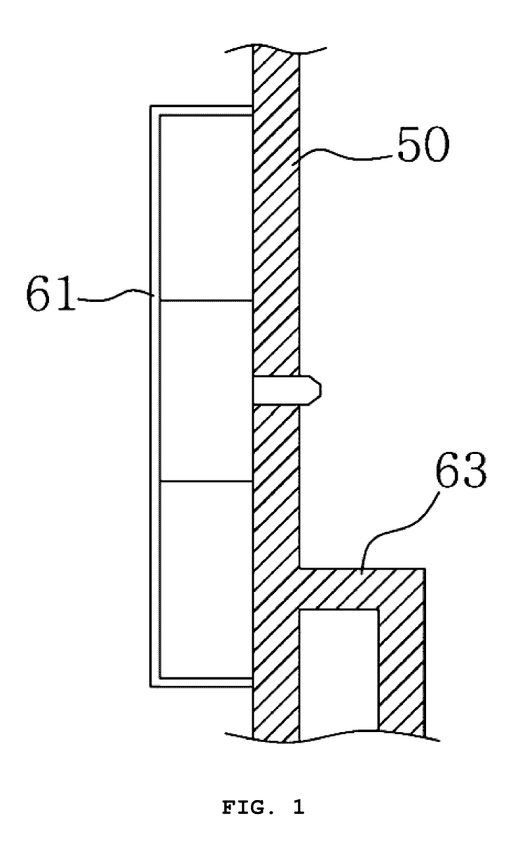

### BEST MODE

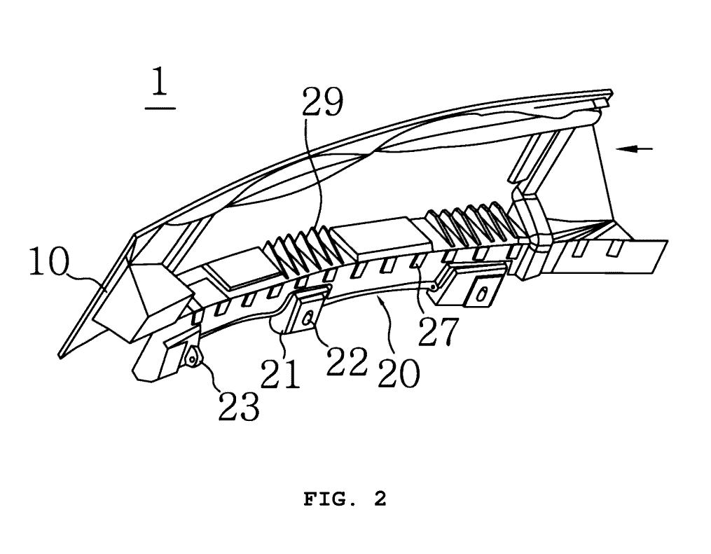

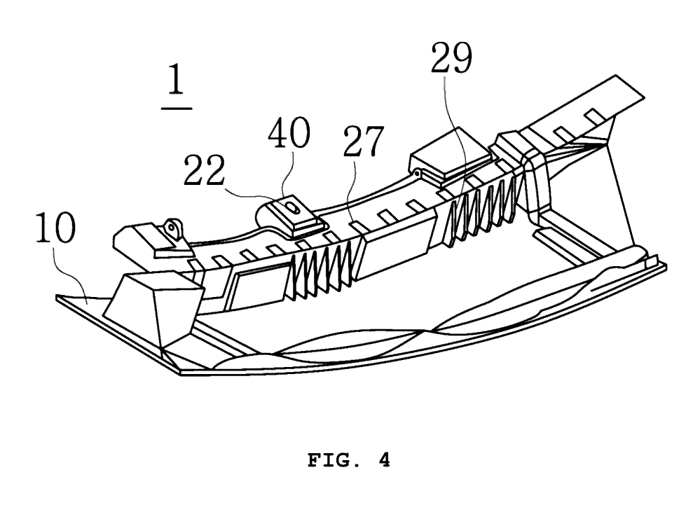

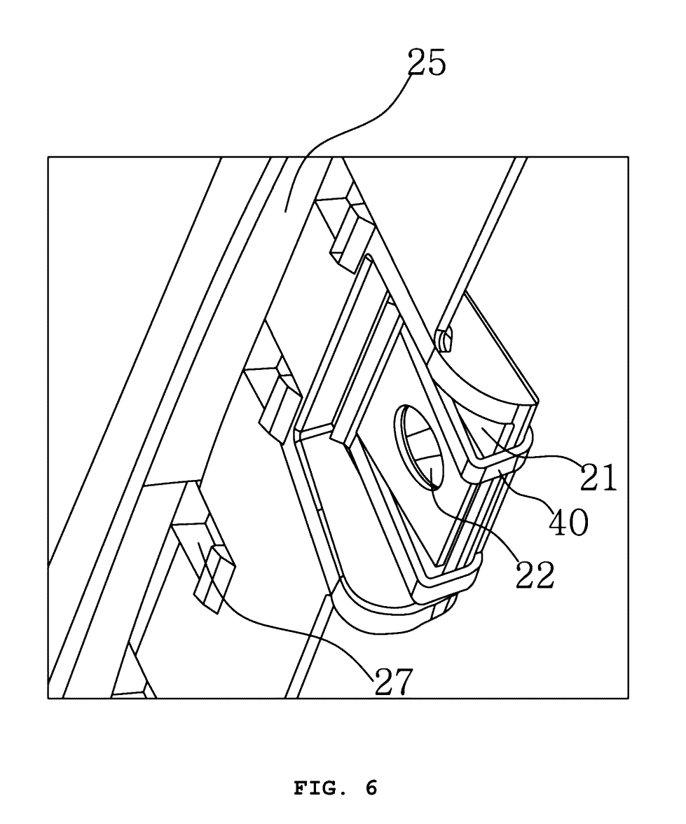

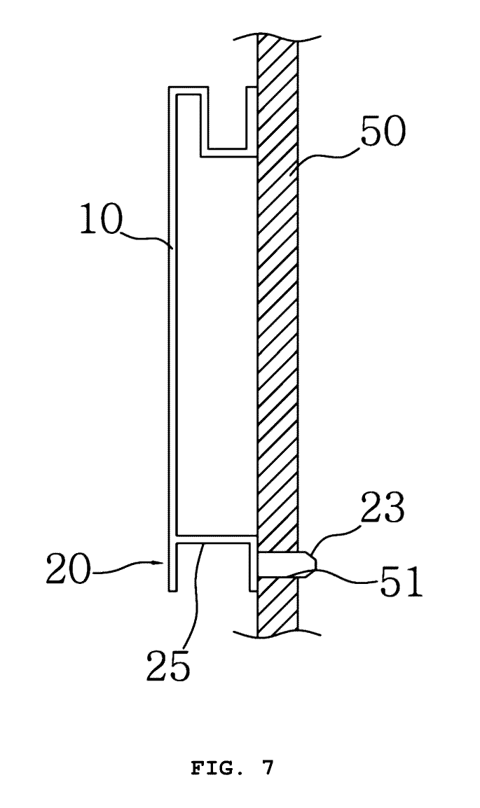

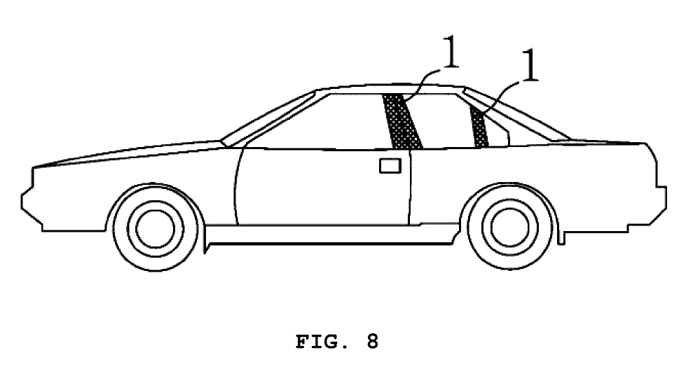

An exemplary embodiment of a door pillar for a vehicle according to the present invention will be described with reference to FIGS. 2 through 8.

A door pillar 1 for a vehicle according to an embodiment of the present invention includes a body part 10, a wing part 20 and a metal clip 40.

The body part 10 is exposed to the outside of the vehicle, and the wing part 20 is coupled to the doorframe of the vehicle to guide the sliding movement of the window. The body part 10 and the wing part 20 in this embodiment are integrally formed through injection molding using synthetic resin.

The wing part 20 is provided with a bracket 21, a protrusion (clip-shape) 23 and a reinforcement rib 29, and is formed with a guide rail 25 and an injection hole 27.

The bracket 21 is formed with a through hole 22 so as to be fastened to the vehicle body (doorframe) 50 by means of a screw. When the door pillar 1 is to be secured to the vehicle, the through hole 22 of the bracket 21 and a screw hole (not shown) formed in the doorframe 50 of the vehicle are aligned and screwed together.

The protrusion 23 is formed in the wing part 20 so as to be inserted into an insertion hole 51 of the doorframe 50 in order to fix the position of the through hole 22. If the protrusion 23 is inserted into the insertion hole 51, the position of the wing part 20 is fixed. At this time, if the protrusion 23 is inserted into the insertion hole 51 of the doorframe 50, the through hole 22 of the bracket 21 is aligned with the screw hole formed in the doorframe 50 of the vehicle. In this way, since the wing part 20 is fixed in such a state that the through hole 22 is aligned with the screw hole by the insertion of the protrusion 23, the wing part 20 can be easily coupled to the vehicle.

The reinforcement rib 29 functions to increase the hardness of the wing part 20. In this embodiment, because the wing part 20 is formed through injection molding using synthetic resin, the hardness of the wing part 20 is lower than that of conventional metal such as aluminum or the like. In order to compensate for this, a plurality of reinforcement ribs 29 is formed so as to be coupled to a portion of the body part 10. The wing part 20 in this embodiment has the reinforcement ribs 29, formed to supplement the thickness of the wing part 20 and increase the hardness thereof, thereby securing sufficient hardness even when using synthetic resin.

In one example, when the thickness of the upper surface of the body part 10 of the door pillar 1 according to the present invention ranges from 3 to 5 mm, the thickness of the reinforcement rib 29 may be set within the range from 1 to 2 mm, and preferably, when the thickness of the upper surface of the body part 10 of the door pillar 1 is 4 mm, the thickness of the reinforcement rib 29 may be set within the range from 1 to 1.2 mm.

This is because it can be known from the experiment results that, if the thickness of the reinforcement rib 29 exceeds 1.2 mm, a sink occurs in the reinforcement rib 29.

This measurement is performed by a commonly used mesh thickness diagnostic program, which shows that the reinforcement rib 29 sags when the thickness of the reinforcement rib is above 1.2 mm, for example, 1.227 mm.

The guide rail 25 functions to guide the sliding movement of the window of the vehicle. A plurality of injection holes 27 is formed in the longitudinal direction of the wing part 20. If the wing part 20 is formed through injection molding using synthetic resin, the wing part may have variation in size during a cooling process. In other words, if the body part 10 and the wing part 20 are integrally formed through injection molding using synthetic resin, they are deformed and thus deteriorated in quality, which makes it difficult to manufacture a door pillar by integrally forming the body part 10 and the wing part 20 using only synthetic resin. The injection holes 27 minimize the variation in size that may occur while an injection-molded synthetic resin is subjected to a cooling process, thereby making it possible to apply the injection-molded synthetic resin to the door pillar. The number of injection holes 27 may be determined by repeatedly performing the injection molding process.

The metal clip 40, through which a screw is inserted, functions to surround the bracket 21 in order to protect the bracket 21. The wing part is coupled to the vehicle body by fastening a screw through the through hole 22 formed in the bracket 21. If a screw is directly fastened into the bracket 21 of synthetic resin, the bracket 21 is likely to be damaged, and for this reason, the metal clip 40 of a metal material surrounds the bracket 21 to protect the same.

According to this embodiment, since the body part 10 and the wing part 20 are integrally formed through injection molding using synthetic resin, the weight of the door pillar is reduced, and further, there is no need to perform roll forming or press processes on metal, thereby simplifying the manufacturing process of the door pillar.

In addition, since the wing part 20 can be easily secured to the vehicle body by inserting the protrusion 23 of the wing part 20 into the insertion hole of the vehicle body, the assembly of the door pillar is facilitated.

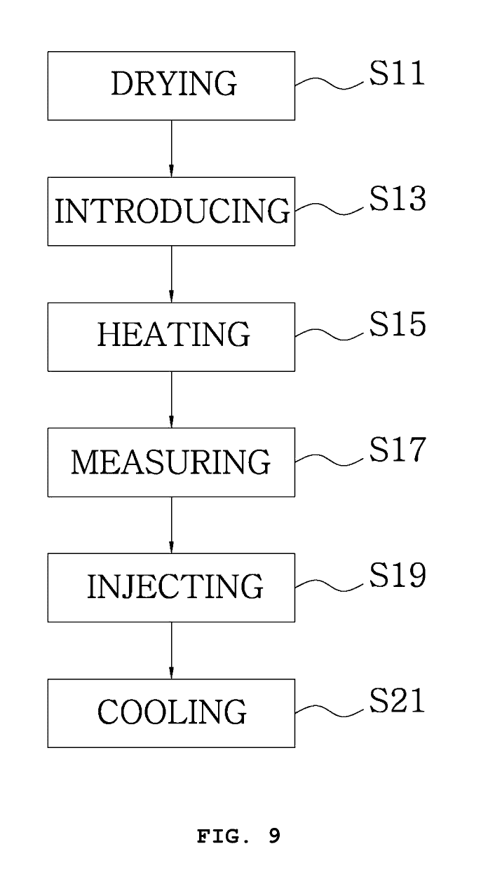

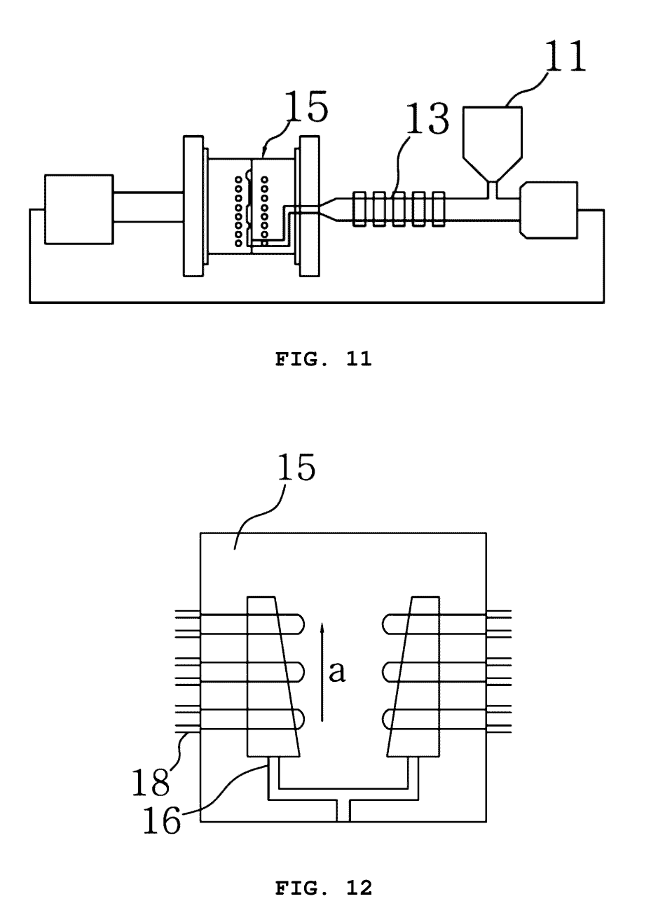

Hereinafter, a method of manufacturing the door pillar 1 constituted as above and a device used for the manufacture thereof will be explained with reference to FIGS. 9 through 12 of the attached drawings.

First, as shown in FIG. 9 of the attached drawings, the method of manufacturing the door pillar for a vehicle according to an embodiment of the present invention includes a drying step S11, an introducing step S13, a heating step S15, a measuring step S17, an injecting step S19, and a cooling step S21.

The door pillar 1 according to the present invention is formed using polymethyl methacrylate (PMMA), and the properties of the polymethyl methacrylate used herein are given in Table 1 below. The door pillar 1 of this embodiment is formed through injection molding using polymethyl methacrylate having the properties shown in Table 1.

TABLE 1

| Property | Condition | Unit | Method | Value |
|---|---|---|---|---|
| Physical | | | | |
| property | | | | |
| Refractive index | Nd | — | ISO 489 | 1.49 |
| Thermal property | | | | |
| Melt flow index | 239/3.8 | g/10 min | ISO 1133 | 2.3 |
| VICAT softening | B/50 | ° C. | ISO 306 | 102 |
| Point | | | | |
| Heat deflection | 1.8 Mpa | ° C. | ISO 75 | 94 |
| temperature | | | | |
| Charpy impact | — | mm/mm/° C. | ASTM D696 | 7 × 10⁻⁵ |
| strength | | | | |
| Mechanical | | | | |
| property | | | | |
| Charpy impact | Unnotched | KJ/m² | ISO 179 | 20 |
| strength | | | le/U | |
| Rockwell | M scale | M scale | ASTM D785 | 100 |
| hardness | | | | |
| Tensile strength | 5 mm/min | Mpa | ISO 527 | 74 |
| Tensile | 5 mm/min | % | ISO 527 | 4.5 |
| elongation | | | | |
| General property | | | | |
| Specific gravity | — | g/cm³ | ISO 1183 | 1.18 |
| Mold shrinkage | — | % | ASTM D955 | 0.2~0.6 |
| Water absorption | 24 hr | % | ASTM D570 | 0.4 |
| Flammability | — | — | UL94 | HB |

In the drying step S11, a polymethyl methacrylate (PMMA) material is introduced into a dehumidifier, and is dried at about 80-95° C. for about 2-3 hours.

In the introducing step S13, polymethyl methacrylate, which has been dried in the drying step S11, is introduced into a cylinder 13 for injection molding. At this time, polymethyl methacrylate, which has been dried in the drying step S11, is introduced into a hopper 11 to be dried once more, and is then introduced into the cylinder 13 from the hopper 11.

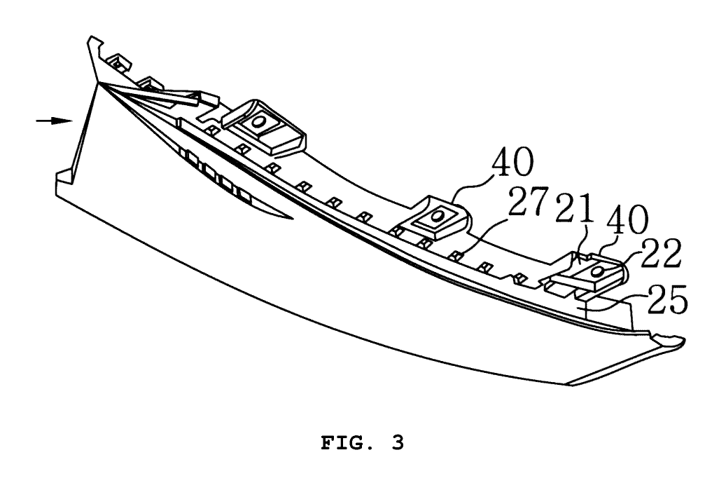

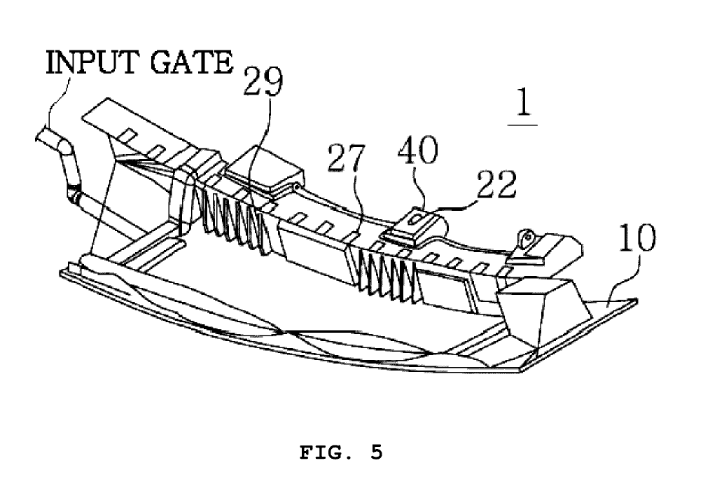

An input gate, as shown in FIG. 5, is provided at a relatively wide region of the door pillar 1 (indicated by the arrows in FIGS. 2 and 3) so that, in the material introducing step S13, the material moves from the relatively wide region toward the relatively narrow region.

The longer the distance from the input gate, the larger the injection pressure for smooth material input. If the material is introduced through the relatively narrow region (opposite the arrow), the injection pressure is applied to the region of the door pillar 1 having relatively low supporting force, which may cause damage to the product.

In the heating step S15, the cylinder 13, into which polymethyl methacrylate has been introduced, is heated at different temperatures in multiple stages along the longitudinal direction thereof. The temperature to which the cylinder 13 is heated is increased in multiple stages, moving from the region near the inlet hole of the cylinder 13 to the region distant from the inlet hole of the cylinder in the longitudinal direction of the cylinder.

In this embodiment, the cylinder 13 is divided into 5 sections, including a nozzle portion, an N1 portion, an N2 portion, an N3 portion and an N4 portion, along the longitudinal direction starting from the nozzle, and the divided sections are heated to different temperatures. The nozzle portion is heated to 235-240° C., the N1 portion is heated to 230-235° C., the N2 portion is heated to 230-235° C., the N3 portion is heated to 225-230° C., and the N4 portion is heated to 215-220° C. Then, polymethyl methacrylate (PMMA) is melted in the cylinder 13.

In the measuring step S17, the amount of polymethyl methacrylate to be used for injection molding is measured in the cylinder 13. The mold should be closed before the measuring is performed.

In the injecting step S19, the measured polymethyl methacrylate is injected into a mold 15 at a constant pressure. At this time, if the injection is performed at a single pressure, polymethyl methacrylate may not be formed into a desired shape. Therefore, in the injecting step S19, polymethyl methacrylate is injected into the mold 15 by applying different pressures thereto in multiple stages. In this embodiment, pressures are applied in three stages, a first stage of which is a constant-pressure stage, in which a pressure of 1750 kg/cm² is applied for injection. A second stage is a holding-pressure stage, in which a pressure of 1050 kg/cm² is applied and maintained constant, and a third stage is a back-pressure stage, in which a pressure of 450 kg/cm² is applied. The pressure applied in this step may be varied in accordance with burrs of the product, humidity, seasonal conditions, etc.

When the door pillar 1 is subjected to injection molding in the injecting step S19, the clamping force of the injection molding machine may be set to be 90 percent or less of the maximum clamping force of the injection molding machine, and the injection pressure may be set to be 80 percent or less of the maximum injection pressure of the injection molding machine.

The mold 15 has an inlet hole 16 formed at one end thereof, and polymethyl methacrylate is injected toward the other end of the mold in the longitudinal direction a.

In the cooling step S21, the mold, into which polymethyl methacrylate has been injected, is cooled. The door filler has a small thickness and a length that is relatively large in comparison with the thickness. Therefore, when polymethyl methacrylate is injected in the mold 15, there is a difference in temperature along the longitudinal direction of the mold 15. That is, the temperature near the inlet hole 16 of the mold, through which polymethyl methacrylate is injected, is relatively high, and the temperature is gradually reduced from the inlet hole 16 to the opposite end of the mold. Conventionally, after a material is injected in the mold, the mold is cooled using cooling water of the same temperature. However, because the mold, which has different temperatures along the longitudinal direction thereof, is cooled by cooling water of the same temperature, there is a problem in that an injection-molded product has weld lines or flow marks and different gloss levels in different regions thereof. Thus, it is necessary to perform a painting process after injection molding.

According to the present invention, in the cooling step S21, the mold 15 is cooled by supplying cooling water at different temperatures to respective cooling water lines 18, which are formed in the mold 15 so as to individually supply cooling water at different temperatures along the longitudinal direction of the mold 15. That is, by using a specially manufactured separate cooling controller, the mold 15 is cooled in such a way that cooling water ranging from a low temperature to a high temperature is supplied to respective cooling water lines 18 disposed from a region near the inlet hole 16 to a region distant from the inlet hole 16 along the longitudinal direction a. In other words, the region near the inlet hole 16 of the mold 15 is relatively hot and the temperature of the mold 15 is gradually reduced toward the region distant from the inlet hole 16, and accordingly, cooling water set to a relatively low temperature is supplied to cool the inlet hole 16 of the mold 15 and cooling water set to a relatively high temperature is supplied to cool regions distant from the inlet hole 16. In this embodiment, the mold 15 is divided into 3 regions and is cooled using cooling water of 45° C. for the region near the inlet hole 16, cooling water of 50° C. for the intermediate region, and cooling water of 55° C. for the region distant from the inlet hole 16. The temperature control may be varied in accordance with the situation in consideration of humidity, seasonal conditions, etc. As a result, the generation of weld lines or flow marks and variation in the gloss level of the surface of the product can be prevented, enabling a painting process to be obviated.

Finally, when the above-described processes are completed, the mold is opened and the molded product is removed from the mold.

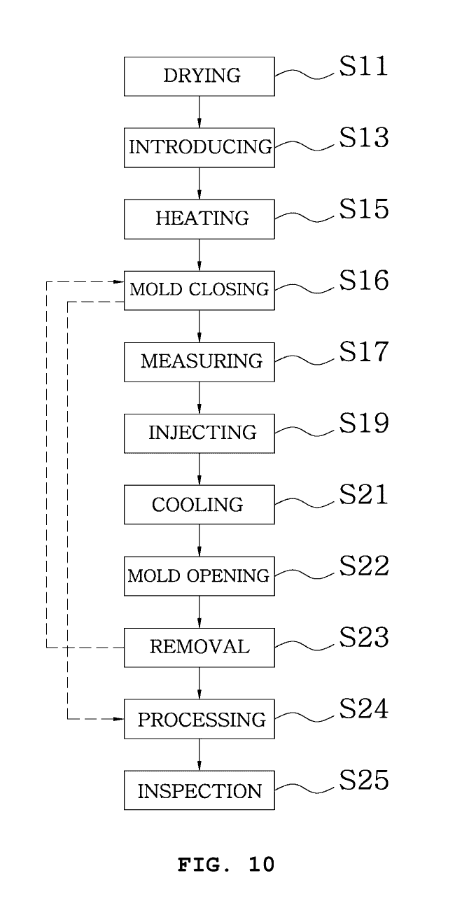

In addition to the above-described previous embodiment, a method of manufacturing the door pillar for a vehicle according to another embodiment of the present invention, as shown in FIG. 10, further includes a mold closing step S16, a mold opening step S22, a removal step S23, a processing step S24, and an inspection step S25, which will be explained with reference to FIG. 10 of the attached drawings.

In explaining the method of manufacturing the door pillar for a vehicle according to another embodiment of the present invention, the same processes as those in the above-described previous embodiment will not be explained again.

The aforementioned mold closing step S16 is a step for closing the mold, which is performed between the heating step S15 and the measuring step S17.

The aforementioned mold opening step S22 is a step for opening the mold, which is performed after the cooling step S21.

The aforementioned mold closing step S16 and mold opening step S22 are similar to opening or closing of the mold in the prior art, and thus a detailed explanation thereof is omitted.

The aforementioned removal step S23 is a step for removing the manufactured molded product from the mold, which is performed after the mold opening step S22. After the removal step S23, the mold closing step S16 may be performed again.

The removal step S23 may be performed by a person (manually) or by a machine (for example, a product removal robot, etc.) (automatically).

The aforementioned processing step S24 is a step for removing a remaining gate from the removed product, which is performed after the mold closing step S16, which is performed after the removal step S23.

Herein, the remaining gate means a trace of residue generated on the product due to the inlet hole through which a material to be injection-molded is introduced, and must be removed after the injection molding.

The aforementioned inspection step S25 is a step for determining the degree of completion and/or the degree of deterioration in the quality of the product, which is performed after the processing step S24.

After the inspection step S25, although not shown in the drawings, the method may further include a sub-component assembly step for completing the door pillar for a vehicle and a packing/shipping step.

According to the present invention as described above, since the manufacturing process can be achieved without a painting process, environmental contamination attributable to a painting process can be prevented, and the manufacturing process can be simplified, thereby improving productivity.

What is claimed is:

1. A door pillar for a vehicle, comprising:
a body part;
a wing part including a bracket having a through hole so as to be secured to a vehicle body using a screw, a protrusion formed to be inserted into the vehicle body in order to fix a position of the through hole, and a guide rail formed to be coupled to a portion of the body part in order to guide sliding movement of a vehicle window; and
a metal clip for surrounding the bracket in order to protect the bracket, the metal clip being formed so that a screw is inserted therethrough,
wherein the body part and the wing part are integrally formed through injection molding using synthetic resin.

2. The door pillar for a vehicle according to claim 1, wherein the wing part further includes a plurality of injection holes formed in a longitudinal direction in order to prevent variation in size during the injection molding using synthetic resin.

3. The door pillar for a vehicle according to claim 2, wherein the wing part further includes a plurality of reinforcement ribs coupled to a portion of the body part in order to increase hardness.

4. The door pillar for a vehicle according to claim 3, wherein, when an upper surface of the body part of the door pillar has a thickness in a range from 3 to 5 mm, the reinforcement rib is formed to have a thickness in a range from 1 to 2 mm.

5. The door pillar for a vehicle according to claim 3, wherein, when an upper surface of the body part of the door pillar has a thickness of 4 mm, the reinforcement rib is formed to have a thickness in a range from 1 to 1.2 mm.

6. A method of manufacturing a door pillar for a vehicle, comprising:
drying polymethyl methacrylate;
introducing the polymethyl methacrylate, which has been dried in the drying, into a cylinder for injection molding;
heating the cylinder, into which the polymethyl methacrylate is introduced, at different temperatures in multiple stages along a longitudinal direction;
measuring an amount of polymethyl methacrylate to be used for injection molding;
injecting the measured polymethyl methacrylate into a mold in a longitudinal direction of the mold by applying pressures ranging from a high level to a low level in multiple stages; and
cooling the mold at different temperatures in multiple stages along the longitudinal direction of the mold from an inlet hole of the mold, through which the polymethyl methacrylate is injected, to an opposite end of the mold.

7. The method according to claim 6, wherein the heating includes heating the cylinder at different temperatures ranging from a low level to a high level in multiple stages from a region near an inlet hole of the cylinder to a region distant from the inlet hole in a longitudinal direction of the cylinder.

8. The method according to claim 6, wherein the cooling includes cooling the mold at different temperatures ranging from a low level to a high level in multiple stages from a region near the inlet hole of the mold to a region distant from the inlet hole in the longitudinal direction of the mold.

9. The method according to claim 8, wherein the cooling includes individually supplying cooling water of different temperatures to respective cooling water lines formed in the mold in multiple stages along the longitudinal direction of the mold.

10. The method according to claim 8, wherein the cooling includes dividing the mold into 3 regions, including a region near the inlet hole of the mold, an intermediate region and a region distant from the inlet hole, along the longitudinal direction of the mold.

11. The method according to claim 6, further comprising:
closing the mold between the heating and the measuring.

12. The method according to claim 6, further comprising:
opening the mold after the cooling.

13. The method according to claim 12, further comprising:
removing a product from the mold after the opening; and
closing the mold after the removing.

14. The method according to claim 13, further comprising:
processing the product to remove a remaining gate from the product after the closing that is performed after the removing.

15. The method according to claim 6, wherein the multiple stages in the injecting include a first stage of a constant pressure, a second stage of a holding pressure, and a third stage of a back pressure.

16. The method according to claim 6, wherein the injecting includes applying an injection pressure set to 80 percent or less of a maximum injection pressure of an injection molding machine and a clamping force set to 90 percent or less of a maximum clamping force of the injection molding machine.

17. The method according to claim 6, wherein the introducing is performed from a wide region of the door pillar toward a narrow region of the door pillar.
